(19) United States
(12) Patent Application Publication
(10) Pub. No.: US 2015/0359235 A1
(43) Pub. Date: Dec. 17, 2015

(54) METHOD FOR PRODUCING FROZEN MINCED FISH MEAT EXCELLENT IN FROZEN-STATE STORAGE STABILITY

(71) Applicant: MARUHA NICHIRO CORPORATION, Koto-ku (JP)

(72) Inventors: Ryusuke NAKASHIMA, Tsukuba-shi (JP); Kazuya SHIROTA, Tsukuba-shi (JP); Kuniaki TATSUTA, Suginami-ku (JP)

(73) Assignee: MARUHA NICHIRO CORPORATION, Koto-ku (JP)

(21) Appl. No.: 14/761,515

(22) PCT Filed: Jan. 20, 2014
(86) PCT No.: PCT/JP2014/050978

§ 371 Date: Jul. 16, 2015

(30) Foreign Application Priority Data
Jan. 18, 2013 (JP) 2013-007924

(51) Int. Cl. A23B 4/09; C09K 15/20; A23L 1/325; C09K 15/32

(52) U.S. Cl. CPC A23B 4/09; C09K 15/32; C09K 15/20; A23L 1/3255; A23V 2002/00

(57) ABSTRACT

The invention provides a method that enables stable production of frozen minced fish meat that is excellent in frozen-state storage stability and is less likely to suffer from decreased gel-forming ability during frozen storage in a practical and productive manner, even when a fish meat raw material contaminated by visceral organs is used. Such method can be applied to the industrial production of minced fish meat. The invention also provides frozen minced fish meat produced by such method. Production of minced fish meat using a fish meat raw material contaminated by visceral organs, and, in particular, the kidneys, which are difficult to remove in the process of production, comprises adding sugar and sugar alcohol, a polymer phosphate, and a non-chelating basic additive other than a polymer phosphate and adjusting the pH level of the minced fish meat to 7.5 or higher using the polymer phosphate and the non-chelating basic additive other than a polymer phosphate.

### TECHNICAL FIELD

The present invention relates to high-quality frozen minced fish meat (surimi, fish paste) that does not suffer from decreased gel-forming ability during frozen storage even when it is a fish meat raw material including visceral organs (the kidney and the spleen, in particular), which is not usually considered suitable as a raw material of minced fish meat, a method for stably producing such frozen minced fish meat, and a technique for improving the frozen-state storage stability of frozen minced fish meat.

### BACKGROUND ART

As fish meat paste products, including crab-flavored, minced, and steamed fish meat paste, become popularized worldwide, the production of frozen minced fish meat has become an industry of a global scale. The market value of frozen minced fish meat is primarily determined on the basis of gel-forming ability; i.e., the resilience of a paste product. In the production of frozen minced fish meat, various additives are generally used to maintain the gel-forming ability during frozen storage.

For example, addition of an agent for preventing a protein from denaturing during frozen storage had been considered to directly stabilize a protein of minced fish meat and improve frozen-state storage stability (Kamaboko, Kouseisha Kouseikaku Co., Ltd., p. 102, 2003). With the addition of a polymer phosphate, also, the pH level of minced fish meat had been maintained in a range at which muscle protein stability would be improved (pH: 7.0 to 7.5), so as to indirectly improve the frozen-state storage stability of minced fish meat (the Journal of the Japanese Society of Fisheries Science, Vol. 51, pp. 667 to 675, 1985). With the addition of a polymer phosphate, fluidity of fish meat during the production of a paste product can be improved, and resilience of a processed product can also be improved (the Journal of the Japanese Society of Fisheries Science, Vol. 57, pp. 1783 to 1788, 1991). From the 1960's to the early 1990's, the meat on the back of a fish body had been mainly used for a raw material of frozen minced fish meat. The meat at this site of a fish can be easily harvested, this site is located at a distance from the visceral organs, and, accordingly, the meat at this site does not include the visceral organs. Thus, such meat is suitable for industrial production of minced fish meat that is continuously and mechanically processed. In the late 1990's, however, a demand for fillets, or so-called cut fish, increased on a global scale. As a consequence, it became difficult to selectively use, as a raw material, the meat on the back of a fish body, which had heretofore been used as a raw material of frozen minced fish meat.

In the production of frozen minced fish meat, accordingly, use of meat surrounding visceral organs, the use of which had been avoided because of its adverse influence on appearance and/or gel-forming ability, became necessary. As techniques for harvesting meat made progress, the meat surrounding the visceral organs that could not be used in the past became harvestable at the industrial level. For example, the meat surrounding the visceral organs and the backbone or the meat on the back of the head of a fish has good quality; however, such meat could not be used in many occasions.

While the production efficiency for frozen minced fish meat was remarkably enhanced because of improved techniques for harvesting meat under insufficient conditions regarding raw materials, disadvantageously, the produced frozen minced fish meat may be more often contaminated by the kidneys. Even when the amount of the contaminating kidneys was very small, paste products produced with the use thereof would be influenced. When frozen minced fish meat of high quality is contaminated, for example, the difference in quality between paste products produced with the use of contaminated frozen minced fish meat and uncontaminated frozen minced fish meat is apparent. Even if the amount of contaminating kidneys is less than an amount equivalent to 1% of the edible parts, products obtained by conventional techniques often suffered from decreased gel-forming ability during the frozen storage, and it was very difficult to stably produce frozen minced fish meat excellent in frozen-state storage stability.

If a technique that enables production of a paste product with stable quality from frozen minced fish meat including the kidneys becomes available, it may lead to expansion of the use of frozen minced fish meat.

In theory, the most effective resolution is to harvest meat while avoiding the contamination of the fish meat as a raw material of the frozen minced fish meat by the kidneys at the time of production. In the process of minced fish meat production at the industrial level by which large quantities of fish bodies are mechanically processed within a short period of time, however, it is practically impossible to completely avoid the contamination by the kidneys for the following reasons. That is, the kidneys are located adjacent to edible parts unlike other visceral organs. By harvesting meat while completely avoiding contamination, accordingly, high-quality fish meat suitable for the production of frozen minced fish meat would be disposed with the kidneys, and the yield would be lowered to a significant extent. Thus, such technique was not practical. Therefore, a method that can stably produce frozen minced fish meat that is less likely to suffer from decreased gel-forming ability during frozen storage, even when a raw material for fish meat contaminated by the kidneys is used, that can be applied to the industrial production of minced fish meat and is practical and high in production efficiency has been awaited.

As a substance that causes deterioration of the quality of fish meat, trimethylamine-N-oxide (hereafter referred to as “TMAO”) had been known. When fish meat extracted from a fish is frozen in that state, TMAO contained in such fish meat is degraded into equal amounts of dimethylamine (hereafter referred to as “DMA”) and formaldehyde (hereafter referred to as “FA”), and FA accelerates denaturing of proteins of the fish meat and causes deterioration of meat quality. As a consequence, deterioration in quality, such as drip occurrence, would be caused.

The simplest method for preventing such problem is to remove TMAO in the fish meat, so that TMAO would not affect the quality. Because TMAO is soluble in water, TMAO can be removed from the target substance by washing the same with an adequate amount of water. Thus, a technique of inhibiting TMAO degradation that had been examined in the past was applied to unleached fish meat that had not been subjected to a step of washing with an adequate amount of water (i.e., fish meat that had not been subjected to so-called “water leaching”), such as minced fish meat (otoshimi), fillet, and cut fish. Examples thereof include a method of adding lactic acid, carbonic acid, phosphoric acid, or an alkali metal salt to fish meat (JP 2004-267109 A) and a method of adjusting the pH level of fish meat to 7 or higher (JP 2005-269960 A).

Production of frozen minced fish meat comprises a step of washing such fish meat with an adequate amount of water, which is referred to as a step of “water leaching (exposing to water).” Since TMAO can be removed to an extent that would not influence the quality of the fish meat, it was common knowledge that deterioration of the quality would not be caused by TMAO. Also, the technique disclosed in JP 2004-267109 A targets fish meat that is not subjected to water leaching. In general, the pH level of minced fish meat is around 7.2, and a polymer phosphate is added. Thus, it satisfies the conditions described in JP 2004-267109 A and JP 2005-269960 A. While both unleached fish meat and minced fish meat are fish meats, it was a common knowledge in the art that the types of deterioration in quality that such fish meats experience during frozen storage are not equal to each other.

As a method for preventing deterioration in quality during frozen storage of minced fish meat, a technique comprising adjusting the pH level to 7.5 to 9, which was employed when the conditions for raw materials for frozen minced fish meat were better than they are at present, was reported in the past (JP S47-23385 B (1972)). When a raw material was contaminated by the kidneys, which are difficult to remove in the process of production, satisfactory effects could not be stably attained, and it was difficult to produce frozen minced fish meat that would not suffer from decreased gel-forming ability during frozen storage.

Frozen minced fish meat is not eaten by itself, and it is used as a raw material for paste products or the like. While a method of improving resilience of a paste product by adjusting the pH level to 8.0 or higher with the addition of a basic additive has been reported (JP 2004-8086 A), muscle protein stability is lowered at such pH level, and an odor is generated. Accordingly, such technique cannot be applied when producing frozen minced fish meat subjected to storage for a long period of time. It is accordingly necessary to minimize the amounts of additives to be incorporated into frozen minced fish meat, so that neither the flavor nor the quality would be influenced when it is processed into a food product. In particular, a polymer phosphate has effects of pH adjustment and effects of resilience improvement when a paste product is processed. Accordingly, a polymer phosphate is generally used as a pH adjuster for frozen minced fish meat. Thus, the use of another type of pH adjuster in addition to a polymer phosphate is not a general practice in the art.

### SUMMARY OF THE INVENTION

### Problems to be Resolved by the Invention

The present inventors conducted concentrated studies concerning the causes of decrease in the gel-forming ability of frozen minced fish meat during frozen storage. As a result, they discovered that, upon contamination of fish meat as a raw material by the kidneys and the spleen at the time of production of frozen minced fish meat, degradation of trimethylamine-N-oxide (hereafter referred to as “TMAO”) remaining in very small amounts in the minced fish meat, which was not a problem when a conventional raw material of frozen minced fish meat was used, would be accelerated to a significant extent, and the gel-forming ability would decrease during frozen storage as a consequence.

### Means for Resolving the Problems

When producing frozen minced fish meat, sugar and sugar alcohol, a polymer phosphate, and a non-chelating basic additive other than a polymer phosphate are mixed, and the pH level of the minced fish meat is adjusted to 7.5 or higher with the use of the polymer phosphate and a non-chelating basic additive other than a polymer phosphate.

Specifically, the present invention is as described below.

[1] A method for producing frozen minced fish meat that is excellent in frozen-state storage stability comprising adding sugar and sugar alcohol, a polymer phosphate, and a non-chelating basic additive other than a polymer phosphate to minced fish meat and adjusting the pH level of the minced fish meat to 7.5 or higher with the polymer phosphate and a non-chelating basic additive other than a polymer phosphate.
[2] A method for producing frozen minced fish meat that is excellent in frozen-state storage stability comprising adjusting the pH level of minced fish meat to 7.0 or higher with a non-chelating basic additive other than a polymer phosphate when subjecting fish meat as a raw material of minced fish meat to water leaching.
[3] The method for producing frozen minced fish meat that is excellent in frozen-state storage stability according to [1] or [2], which involves the use of fish meat as a raw material contaminated by the kidneys, which are difficult to remove in the production process.
[4] The method for producing frozen minced fish meat that is excellent in frozen-state storage stability according to any of [1] to [3], wherein the non-chelating basic additive other than a polymer phosphate is selected from the group consisting of sodium bicarbonate, sodium carbonate, arginine, and sodium hydroxide.
[5] The method for producing frozen minced fish meat that is excellent in frozen-state storage stability according to any of [1], [3], and [4], wherein the polymer phosphate is selected from the group consisting of sodium pyrophosphate, sodium tripolyphosphate, and sodium polyphosphate.
[6] The method for producing frozen minced fish meat that is excellent in frozen-state storage stability according to any of [1] and [3] to [5], wherein sugar and sugar alcohol are selected from the group consisting of sucrose, sorbitol, glucose, and maltose.
[7] The method for producing frozen minced fish meat that is excellent in frozen-state storage stability according to any of [1] and [3] to [6], wherein sugar and sugar alcohol, the polymer phosphate, and the non-chelating basic additive other than a polymer phosphate are added in amounts of 1% to 20% (w/w), 0.01% to 5% (w/w), and 0.01% to 5% (w/w), respectively, relative to the total weight of the minced fish meat.
[8] The method for producing frozen minced fish meat that is excellent in frozen-state storage stability according to [2], wherein sodium bicarbonate is added in an amount of 0.1% (w/w) or more to water used for water leaching of fish meat.
[9] The method for producing frozen minced fish meat that is excellent in frozen-state storage stability according to any of [1] to [8], wherein the fish meat as a raw material is selected from the group consisting of Alaska pollack, southern blue whiting, Pacific whiting, lizardfish, New Zealand hoki, mackerel, and saury.
[10] Frozen minced fish meat produced by the method according to any of [1] to [9].
[11] A fish meat paste product produced using the frozen minced fish meat according to [10] as a raw material.
[12] A degradation inhibitor of trimethylamine-N-oxide (TMAO) of frozen minced fish meat comprising sugar and sugar alcohol, a polymer phosphate, and a non-chelating basic additive other than a polymer phosphate.
[13] The degradation inhibitor of trimethylamine-N-oxide (TMAO) according to [12], wherein the TMAO is derived from a visceral organ of a fish.
[14] The degradation inhibitor of trimethylamine-N-oxide (TMAO) according to [12] or [13], wherein the non-chelating basic additive other than a polymer phosphate is selected from the group consisting of sodium bicarbonate, sodium carbonate, arginine, and sodium hydroxide.
[15] The degradation inhibitor of trimethylamine-N-oxide (TMAO) according to any of [12] to [14], wherein the polymer phosphate is selected from the group consisting of, for example, sodium pyrophosphate, sodium tripolyphosphate, and sodium polyphosphate.
[16] The degradation inhibitor of trimethylamine-N-oxide (TMAO) according to any of [12] to [15], wherein sugar and sugar alcohol are selected from the group consisting of sucrose, sorbitol, glucose, and maltose.
[17] The degradation inhibitor of trimethylamine-N-oxide (TMAO) according to any of [12] to [16], which comprises sugar and sugar alcohol, the polymer phosphate, and the non-chelating basic additive other than a polymer phosphate in amounts of 1% to 20% (w/w), 0.01% to 5% (w/w), and 0.01% to 5% (w/w), respectively, relative to the total weight of the minced fish meat.

This description includes part or all of the content as disclosed in the description and/or drawings of Japanese Patent Application No. 2013-007924, which is a priority document of the present application.

### Effects of the Invention

The present invention provides a method that enables stable production of frozen minced fish meat that is excellent in frozen-state storage stability and is less likely to suffer from decreased gel-forming ability during frozen storage in a practical and productive manner, even when a fish meat raw material contaminated by the kidneys, which are difficult to remove in the process of production and cause TMAO degradation leading to deteriorated frozen-state storage stability, is used. Also, such method can be applied to the industrial production of minced fish meat. The present invention also provides frozen minced fish meat produced by such method.

### BRIEF DESCRIPTION OF THE DRAWINGS

FIG. 1 shows the amount of DMA in minced fish meat mixed with visceral organs and stored at −10° C. for 2 weeks.

FIG. 2 shows a change in resilience when minced fish meat is mixed with the kidneys and stored at −20° C. for 6 months, wherein A indicates the breaking strength, and B indicates the distance until breaking.

FIG. 3 shows a change in the amount of DMA in minced fish meat when such minced fish meat is mixed with the kidneys and stored at −20° C. for 6 months.

FIG. 4 shows a change in solubility of myofibrillar proteins in salt in minced fish meat when such minced fish meat is mixed with the kidneys and stored at −20° C. for 6 months.

FIG. 5 shows the results of a comparison of effects of various additives for inhibiting TMAO degradation in minced fish meat contaminated by the kidneys.

FIG. 6 shows the effects of various additives for inhibiting TMAO degradation. FIG. 6 shows the amount of DMA in minced fish meat when such minced fish meat containing the kidneys in an amount that is 0.5% thereof is further mixed with various additives and then subjected to frozen storage at −10° C. for 2 weeks. Values in parentheses indicate pH levels of the minced fish meat.

FIG. 7 shows effects of various additives for inhibiting a decrease in resilience. FIG. 7 shows the resilience of the minced fish meat as shown in FIG. 6.

FIG. 8 shows physical properties of minced fish meat attained when 0.1%, 0.2%, or 0.4% sodium bicarbonate is added when subjecting such fish meat to water leaching. FIG. 8A shows the breaking strength and FIG. 8B shows the distance until breaking.

FIG. 9 shows the amount of DMA produced in minced fish meat when 0.1%, 0.2%, or 0.4% sodium bicarbonate is added when subjecting such fish meat to water leaching.

### EMBODIMENTS FOR CARRYING OUT THE INVENTION

Hereafter, the present invention is described in detail.

According to the present invention, frozen minced fish meat (fish paste) can be produced using fish meat including visceral organs as a raw material by adding sugar and sugar alcohol, a polymer phosphate, and a non-chelating basic additive other than a polymer phosphate thereto and adjusting the pH level of the minced fish meat to 7.5 or higher with the polymer phosphate and the non-chelating basic additive other than a polymer phosphate. Alternatively, the pH level of the minced fish meat may be adjusted to 7.0 or higher with a polymer phosphate and a non-chelating basic additive other than a polymer phosphate.

The present invention is effective when fish meat serving as a raw material of frozen minced fish meat is contaminated by visceral organs, such as the kidneys (the head kidney and the trunk kidney, and the head kidney, in particular) and the spleen, which degrade TMAO and deteriorate frozen-state storage stability. In accordance with a method of preparing fish meat as a raw material, accordingly, the substance of interest may not be contaminated by such substances. In practice, it is difficult to determine whether or not the substance of interest is contaminated by the kidneys or the spleen. In general, frozen minced fish meat may be produced in accordance with the method of the present invention with or without contamination based on the assumption that the fish meat as a raw material is contaminated by the kidneys or the spleen. Even when contamination of the fish meat by the kidneys is apparent, removal thereof is difficult.

The effects of the present invention can be attained by adding 1% to 20% (w/w) of sugar and sugar alcohol, 0.01% to 5% (w/w) of a polymer phosphate, and 0.01% to 5% (w/w) of a non-chelating basic additive other than a polymer phosphate, and preferably 3% to 15% (w/w) of sugar and sugar alcohol, 0.1% to 1% (w/w) of a polymer phosphate, and 0.01% to 1% (w/w) of a non-chelating basic additive other than a polymer phosphate, and, more preferably 5% to 10% (w/w) of sugar and sugar alcohol, 0.1% to 0.5% (w/w) of a polymer phosphate, and 0.01% to 1% (w/w) of a non-chelating basic additive other than a polymer phosphate, respectively, relative to the total weight of the minced fish meat.

Examples of sugar and sugar alcohol that can be used include sucrose, sorbitol, glucose, and maltose. Sucrose is preferable, and sorbitol is more preferable, although sugar and sugar alcohol are not limited thereto. Also, such substances can be used in combination.

Examples of a polymer phosphate that can be used include sodium pyrophosphate, sodium tripolyphosphate, and sodium polyphosphate, with sodium pyrophosphate and sodium polyphosphate being preferable, although such polymer phosphate is not limited thereto. Also, such substances can be used in combination.

Examples of a non-chelating basic additive other than a polymer phosphate that can be used include sodium bicarbonate, sodium carbonate, arginine, and sodium hydroxide, with arginine being preferable and sodium bicarbonate being more preferable, although such additive is not limited thereto. Also, such substances can be used in combination. It should be noted that compounds having chelating activity, such as sodium acetate, sodium gluconate, and sodium glutamate, cannot exert the effects of the present invention even if they are basic compounds. A non-chelating basic additive other than a polymer phosphate may also be referred to as a basic compound without chelating activity other than a polymer phosphate.

A fish species is not particular limited, provided that such fish is used as a raw material of minced fish meat. In particular, a fish in which TMAO degradation takes place can exert remarkable effects. Examples of such fish species include Alaska pollack, southern blue whiting, Pacific whiting, lizardfish, New Zealand hoki, mackerel, and saury. Alaska pollack, southern blue whiting, Pacific whiting, and lizardfish are preferable, with Alaska Pollack being more preferable.

According to the method of the present invention, sugar and sugar alcohol, a polymer phosphate, and a non-chelating basic additive other than a polymer phosphate are added to minced fish meat, and the resultant is thoroughly mixed, followed by frozen storage. Thus, frozen minced fish meat can be produced. Alternatively, the frozen minced fish meat may be thawed, sugar and sugar alcohol, a polymer phosphate, and a non-chelating basic additive other than a polymer phosphate may be added thereto, and these substances may be thoroughly mixed, followed by frozen storage. In such a case, frozen-state storage stability is improved after sugar and sugar alcohol, a polymer phosphate, and a non-chelating basic additive other than a polymer phosphate are added. In the present invention, minced fish meat that is frozen at the end is referred to as “frozen minced fish meat.”

In addition, it is not necessary to add basic additives directly to minced fish meat. Similar effects can be attained with the addition of such basic additives to a raw material of minced fish meat when such fish meat is subjected to water leaching (exposing to water). Water leaching is a step of washing fish meat with an adequate amount of water prior to the production of minced fish meat. Basic additives may be added to water used for water leaching. The amount of basic substances to be added to water used for water leaching is 0.1% to 1% (w/w) of the amount of a non-chelating basic additive other than a polymer phosphate. Sodium bicarbonate may be added in an amount that is preferably 0.1% to 1% (w/w), more preferably 0.2% to 0.5% (w/w), and further preferably 0.2% to 0.4% (w/w). The pH level of an aqueous solution of basic substances used for water leaching is 7.0 or higher, preferably 7.1 or higher, and more preferably 7.3 or higher. Water leaching may be carried out by, for example, mixing fish meat into an aqueous solution for water leaching at a ratio of 1:1 to 1:3, and preferably 1:1 to 1:2, by weight, and agitating the resulting mixture for several minutes, such as 3 to 8 minutes, and preferably 4 to 5 minutes. Agitation may be carried out using a tank equipped with agitation blades. When minced fish meat is produced with the use of fish meat as a raw material subjected to water leaching with the aqueous solution described above, the pH level of the resulting minced fish meat is 7.4 or higher, and preferably 7.5 or higher.

If basic additives are added when fish meat as a raw material of minced fish meat is subjected to water leaching, sugar and sugar alcohol, and a polymer phosphate are added at the time of production of the frozen minced fish meat, following water leaching.

With the addition of basic substances to fish meat as a raw material of minced fish meat, physical properties, such as setting ability, become improved, and the amount of DMA produced further decreases. Compared with cases in which basic substances are not added, for example, the amount of DMA produced after the minced fish meat has been stored at −10° C. for 2 weeks decreases by 10% or more, preferably 25% or more, and more preferably 30% or more.

The present invention includes an agent for improving frozen-state storage stability of frozen minced fish meat comprising sugar and sugar alcohol, a polymer phosphate, and a non-chelating basic additive other than a polymer phosphate. Sugar and sugar alcohol, the polymer phosphate, and the non-chelating basic additive other than a polymer phosphate contained in such agent for improving frozen-state storage stability are as described above. The content of such substances may be determined so as to adjust the amounts of sugar and sugar alcohol to 1% to 20% (w/w), the polymer phosphate to 0.01% to 5% (w/w), and the non-chelating basic additive other than a polymer phosphate to 0.01% to 5% (w/w), preferably sugar and sugar alcohol to 3% to 15% (w/w), the polymer phosphate to 0.1% to 1% (w/w), and the non-chelating basic additive other than a polymer phosphate to 0.01% to 1% (w/w), and more preferably sugar and sugar alcohol to 5% to 10% (w/w), the polymer phosphate to 0.1% to 0.5% (w/w), and the non-chelating basic additive other than a polymer phosphate to 0.01% to 1% (w/w), respectively, relative to the total weight of the minced fish meat, when the agent for improving frozen-state storage stability is added to the minced fish meat, by taking the amount of the minced fish meat and the amount of the agent for improving frozen-state storage stability to be incorporated into consideration.

An agent for improving frozen-state storage stability of frozen minced fish meat may be occasionally referred to as an agent for improving the frozen-state storage stability of frozen minced fish meat or a degradation inhibitor of TMAO. TMAO to be inhibited from degradation is derived from visceral organs of a fish such as the kidneys (the head kidney and the trunk kidney, with the head kidney being particularly preferable) and the spleen.

Trimethylamine-N-oxide (TMAO) that had been included in the frozen minced fish meat produced by the method of the present invention during frozen storage would not be degraded into dimethylamine (DMA) and formaldehyde (FA). Thus, such frozen minced fish meat would be excellent in frozen-state storage stability, and it would be less likely to suffer from decreased gel-forming ability during frozen storage. In addition, a myofibrillar protein would not be denatured. The gel-forming ability during frozen storage can be determined by, for example, producing a paste product, such as kamaboko, using, as a raw material, the frozen minced fish meat produced by the method of the present invention and assaying the breaking strength or the distance until breaking of the product. The breaking strength and the distance until breaking of such paste product are greater than those of a paste product produced using frozen minced fish meat prepared without the addition of sugar and sugar alcohol, a polymer phosphate, or a non-chelating basic additive other than a polymer phosphate. The breaking strength and the distance until breaking can be assayed by the method described in the examples below. An example of an apparatus for assaying the breaking strength and the distance until breaking that can be used is the SUN REO METER CR-500DX (Sun Scientific Co., Ltd.). In addition, the amount of DMA in the frozen minced fish meat produced by the method of the present invention is lower than the amount of DMA in the frozen minced fish meat produced without the addition of sugar and sugar alcohol, a polymer phosphate, or a non-chelating basic additive other than a polymer phosphate. When evaluation is made in terms of solubility in a salt solution (0.5M KCl, 20 mM Tris-HCl, pH 7.5) in the frozen minced fish meat produced by the method of the present invention, the degree of denaturation of the myofibrillar protein (actomyosin) is lower than the degree of denaturation of the myofibrillar protein in the frozen minced fish meat produced without the addition of sugar and sugar alcohol, a polymer phosphate, or a non-chelating basic additive other than a polymer phosphate.

The present invention includes frozen minced fish meat produced by the method for producing frozen minced fish meat that is excellent in frozen-state storage stability according to the present invention and a fish meat paste product produced using such frozen minced fish meat as a raw material. Examples of fish meat paste products include steamed minced-fish cake (kamaboko), bamboo-leaf-shaped fish loaf (sasa-kamaboko), fish meat sausage, fish minced and steamed (hanpen), tubular fish sausage (chikuwa), and sweet rolled omelette (datemaki).

### EXAMPLES

The present invention is described in greater detail with reference to the following examples, although the scope of the present invention is not limited to these examples.

### Example 1

### Degradation of TMAO in Minced Fish Meat Caused by Contamination by Visceral Organs

### (Method)

The degree of degradation of trimethylamine-N-oxide (TMAO) remaining in the minced fish meat mixed with various organs was inspected. Organs were extracted from Alaska Pollack and homogenized using a food cutter. The resulting paste was added to commercially available Alaska Pollack minced fish meat in an amount accounting for 2% thereof and the resultant was subjected to frozen storage at −10° C. for 2 weeks. Thereafter, the amount of dimethylamine (DMA) in the minced fish meat was measured to evaluate the degree of TMAO degradation. DMA was quantified by the copper-dithiocarbamate method.

### (Results)

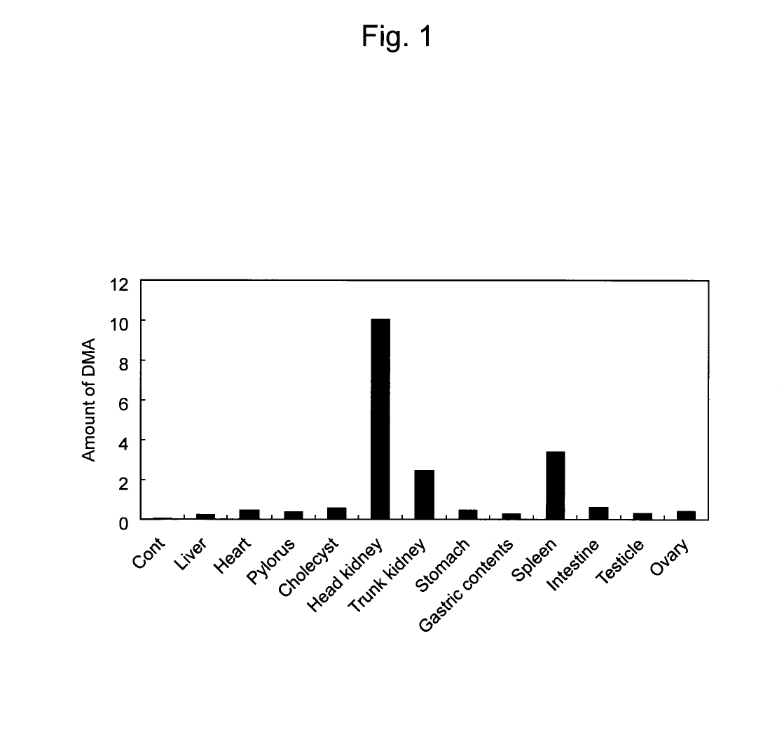

FIG. 1 shows the amount of DMA in the minced fish meat mixed with various visceral organs and then stored at −10° C. for 2 weeks. While substantially no DMA was observed in the Control group to which no visceral organs had been added, an increase in the amount of DMA was observed in the minced fish meat with the addition of visceral organs, and degradation of TMAO remaining in the minced fish meat was confirmed. When the kidneys and the spleen were added, such phenomenon was particularly remarkable.

### Example 2

### Decreased Gel-Forming Ability of Minced Fish Meat During Frozen Storage Caused by Contamination by Visceral Organs

### (Method)

Whether or not TMAO degradation caused by contamination by visceral organs would lead to decreased gel-forming ability of minced fish meat during frozen storage was inspected. An Alaska pollack kidney paste was added to a commercially available Alaska pollack frozen minced fish meat in an amount accounting for 1% thereof, and the resultant was mixed using a food cutter. The resulting minced fish meat was subjected to frozen storage at −20° C. for 6 months. The gel-forming ability, the amount of DMA, and the degree of myofibrillar protein denaturation of the minced fish meat after storage were analyzed. The gel-forming ability was evaluated by preparing kamaboko with the addition of salt to the minced fish meat in an amount accounting for 3% thereof and measuring the breaking strength and the distance until breaking using the SUN REO METER CR-500DX (Sun Scientific Co., Ltd.).

The degree of myofibrillar protein denaturation was evaluated on the basis of solubility in a salt solution (0.5 M KCl, 20 mM Tris-HCl, pH 7.5).

### (Results)

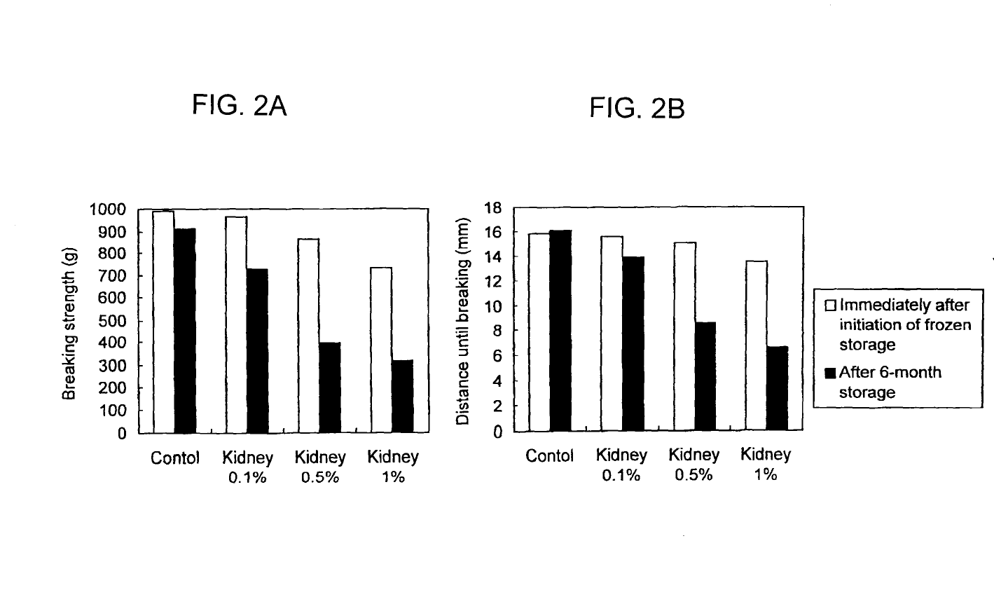

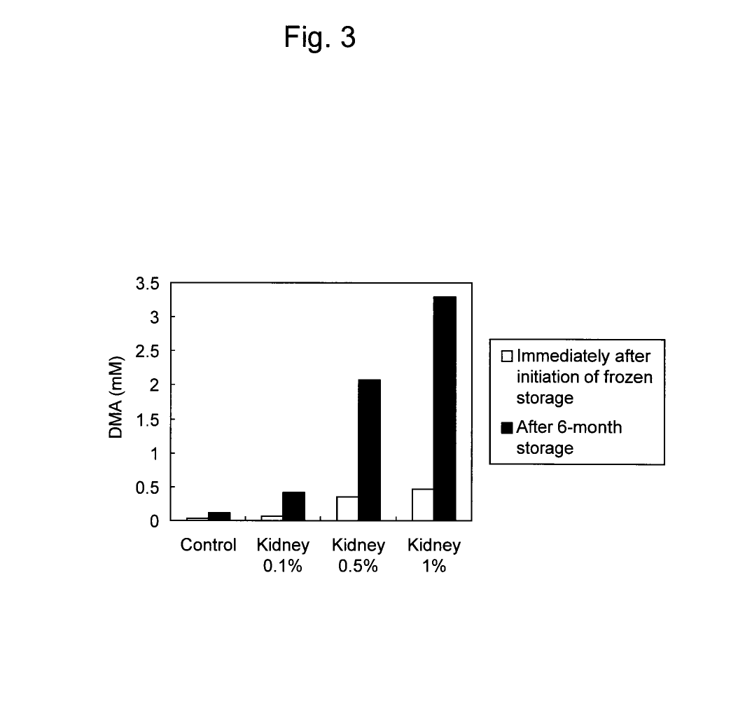

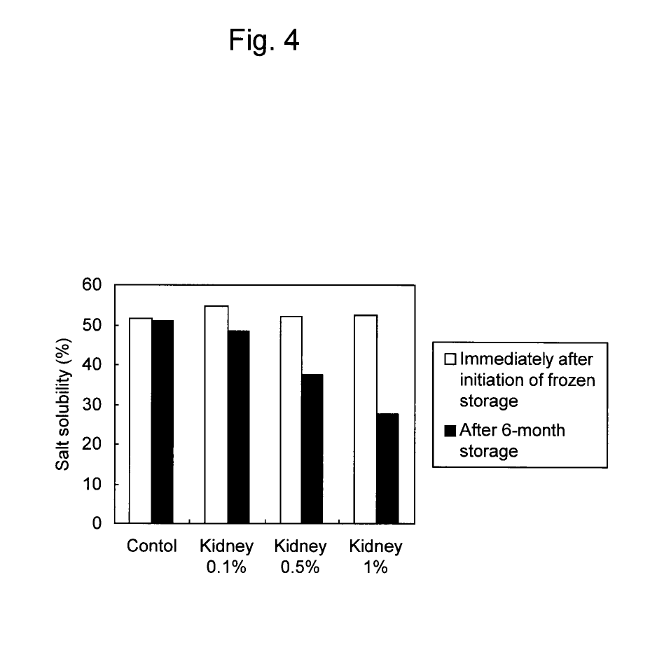

FIG. 2 shows a change in resilience when minced fish meat is mixed with the kidneys and stored at −20° C. for 6 months, wherein A indicates the breaking strength, and B indicates the distance until breaking. FIG. 3 shows a change in the amount of DMA in minced fish meat when such minced fish meat is mixed with the kidneys and stored at −20° C. for 6 months. Further, FIG. 4 shows a change in solubility of myofibrillar proteins of minced fish meat in salt when the minced fish meat is mixed with the kidneys and stored at −20° C. for 6 months.

While no significant changes were observed in the gel-forming ability or in the myofibrillar protein properties in the group to which the kidneys had been added immediately after the initiation of frozen storage, an extreme decrease in the gel-forming ability, TMAO degradation, and myofibrillar protein denaturation were observed during frozen storage at −20° C.

### Example 3

### Additives that Inhibit TMAO Degradation Occurring in Minced Fish Meat Contaminated by Visceral Organs

### (Method)

The effects of various additives for inhibiting TMAO degradation were inspected. An Alaska pollack kidney paste was added to commercially available Alaska pollack frozen minced fish meat in an amount accounting for 1% thereof, and the resultant was mixed using a food cutter. Further, various additives (e.g., sodium bicarbonate, sodium carbonate, arginine, sodium hydroxide, sodium polyphosphate, sodium acetate, sodium gluconate, sodium sulfate, and sodium glutamate) were added and mixed therewith, and the resulting minced fish meat was subjected to frozen storage at −10° C. for 2 weeks. The amount of DMA increased after storage was inspected, and the effects of various additives for inhibiting TMAO degradation were evaluated.

### (Results)

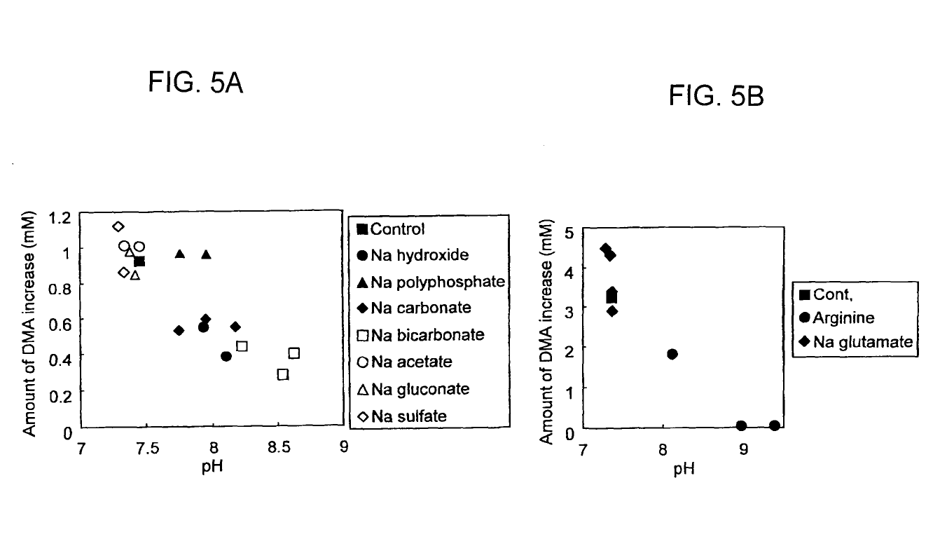

FIG. 5 shows the results of a comparison of effects of various additives for inhibiting TMAO degradation in minced fish meat contaminated by the kidneys, wherein A shows the results attained with the addition of sodium hydroxide, sodium polyphosphate, sodium carbonate, sodium bicarbonate, sodium acetate, sodium gluconate, and sodium sulfate, and B shows the results attained with the addition of arginine and sodium glutamate. The addition of a non-chelating basic additive other than a polymer phosphate (i.e., sodium bicarbonate, sodium carbonate, arginine, or sodium hydroxide) was found to inhibit TMAO degradation occurring in the minced fish meat contaminated by the kidneys.

### Example 4

### Effects of Inhibiting Decrease in Gel-Forming Ability of Minced Fish Meat with the Addition of Degradation Inhibitor of TMAO

### (Method)

Effects of various degradation inhibitors of TMAO for inhibiting decreases in the gel-forming ability of minced fish meat contaminated by various visceral organs during frozen storage were inspected. An Alaska pollack kidney paste was added to commercially available Alaska pollack frozen minced fish meat in an amount accounting for 0.5% thereof, and the resultant was mixed using a food cutter. Various additives were further added and mixed therewith, and the resulting minced fish meat was subjected to frozen storage at −10° C. for 2 weeks. Thereafter, the gel-forming ability and the amount of DMA increased of the minced fish meats were inspected. The group to which no kidneys had been added was designated “Blank,” the group to which the kidneys had been added was designated “Control,” and effects of various degradation inhibitors of TMAO for inhibiting a decrease in the gel-forming ability during frozen storage were evaluated on the basis of the breaking strength. The sample that was boiled immediately after frozen storage and the sample that was allowed to set for 1 hour were used for the evaluation of the breaking strength.

### (Results)

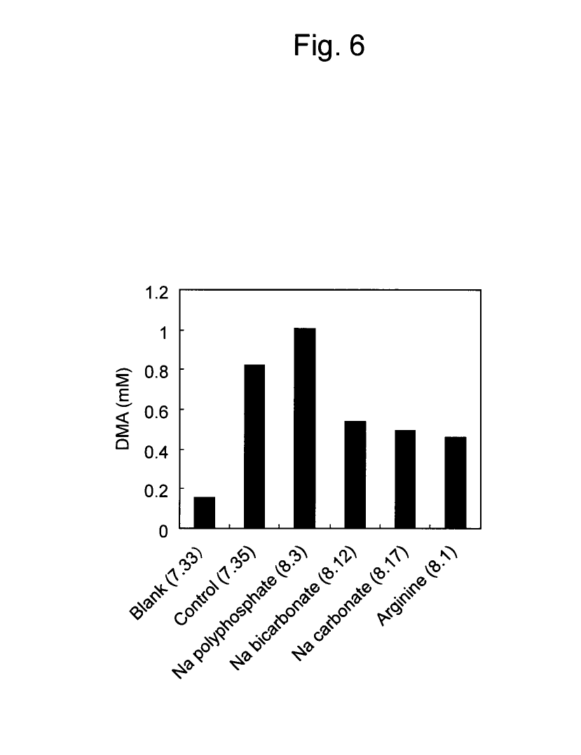

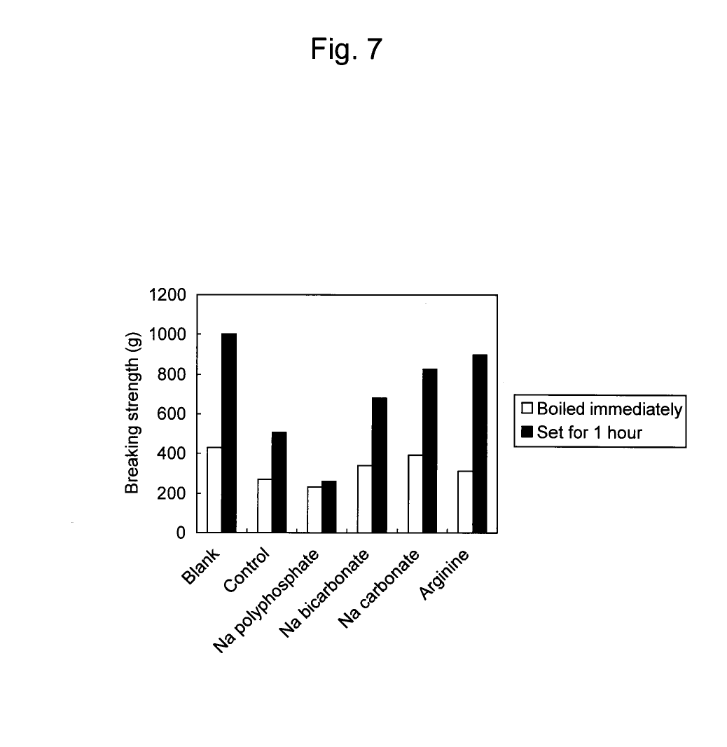

FIG. 6 shows the effects of various additives for inhibiting TMAO degradation. FIG. 6 shows the amount of DMA in minced fish meat when minced fish meat containing the kidneys in an amount accounting for 0.5% thereof is further mixed with various additives and then subjected to frozen storage at −10° C. for 2 weeks. Values in parentheses indicate pH levels of the minced fish meat. FIG. 7 shows effects of various additives for inhibiting decreases in resilience. FIG. 7 shows the resilience of the minced fish meat that is the subject of FIG. 6. In the Control group to which the kidneys alone had been added, the extent of TMAO degradation and that of the decrease in the gel-forming ability during frozen storage were greater than those observed in the Blank group to which no kidneys had been added. In contrast, effects of inhibiting TMAO degradation were observed in both the sample that was boiled immediately after frozen storage and the sample that was allowed to set for 1 hour in the test groups to which various degradation inhibitors of TMAO had been added. In addition, the decrease in the gel-forming ability observed in the test group was not as significant as that observed in the Control group.

### Example 5

### Effects of Addition of Degradation Inhibitor of TMAO Upon Water Leaching of Fish Meat

### (Method)

Sodium bicarbonate powder was directly introduced into a water leaching tank generally used for the production at a minced fish meat factory, and water was mixed therewith in order to prepare an aqueous sodium bicarbonate solution.

Water (400 liters) was introduced into the tank. Thus, the content of the tank was divided into 4 groups, to which 0 g of sodium bicarbonate was added (the Control group), 0.4 kg thereof was added (the 0.1% sodium bicarbonate solution group), 0.8 kg thereof was added (the 0.2% sodium bicarbonate solution group), and 1.6 kg thereof was added (the 0.4% sodium bicarbonate solution group). The ratio of the weight of the meat subjected to water leaching to that of the aqueous solution was 1:1.6 (250 kg:400 kg).

The pH levels of aqueous solutions of the test groups are as shown in Table 1.

TABLE 1

| Test group | pH |
|---|---|
| Control group | 6.90 |
| 0.1% Sodium bicarbonate solution group | 7.19 |
| 0.2% Sodium bicarbonate solution group | 7.39 |
| 0.4% Sodium bicarbonate solution group | 7.50 |

After water leaching was carried out under the conditions described above, minced fish meat was produced in accordance with a conventional procedure. The pH levels of the different types of produced minced fish meat are as shown in Table 2.

TABLE 2

| Test group | pH |
|---|---|
| Control group | 7.28 |
| 0.1% Sodium bicarbonate solution group | 7.47 |
| 0.2% Sodium bicarbonate solution group | 7.59 |
| 0.4% Sodium bicarbonate solution group | 7.85 |

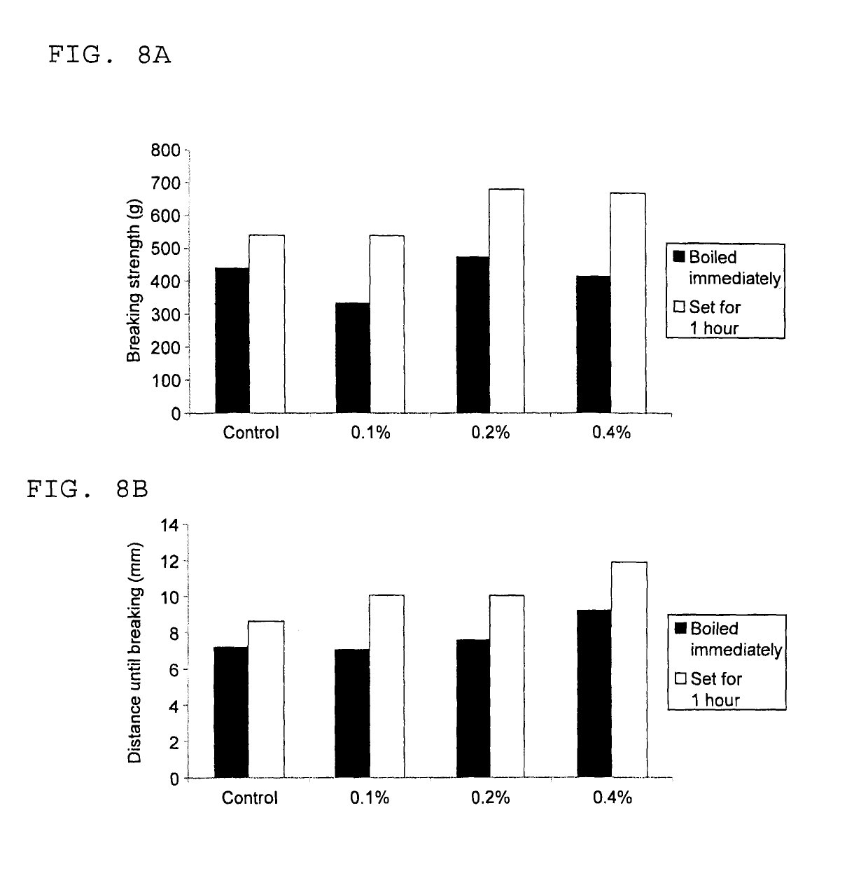

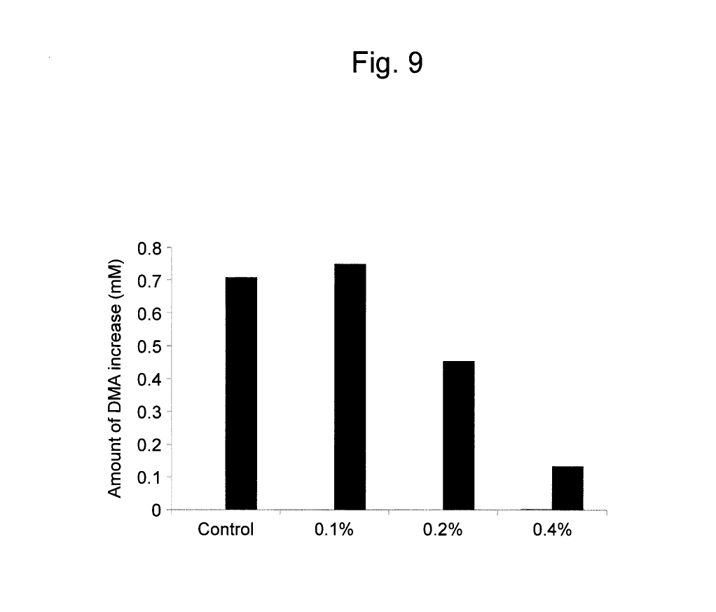

FIG. 8 shows physical properties (a change in resilience) of the produced minced fish meat attained after being stored at −10° C. for 2 weeks. FIG. 8A shows the breaking strength when 0.1%, 0.2%, or 0.4% sodium bicarbonate was added, and FIG. 8B shows the distance until breaking. FIG. 9 shows the amount of DMA produced (the amount thereof increased). As shown in FIG. 8, the addition of sodium bicarbonate at the time of water leaching did not adversely affect physical properties. In fact, the setting ability was improved. As shown in FIG. 9, DMA production was decreased in a concentration-dependent manner, and it was inhibited by 30% in the 0.2% sodium bicarbonate solution group and by 80% in the 0.4% sodium bicarbonate solution group, compared with the Control group.

### INDUSTRIAL APPLICABILITY

The present invention enables stable production of minced fish meat excellent in frozen-state storage stability, which had been impossible to achieve in the past, at the industrial level.

All publications, patents, and patent applications cited herein are incorporated herein by reference in their entirety.

1. A method for producing frozen minced fish meat that is excellent in frozen-state storage stability comprising adding (i) a sugar and/or a sugar alcohol, (ii) a polymer phosphate, and (iii) a non-chelating basic additive other than a polymer phosphate to minced fish meat and adjusting the pH level of the minced fish meat to 7.5 or higher with the polymer phosphate and the non-chelating basic additive other than a polymer phosphate.

2. A method for producing frozen minced fish meat that is excellent in frozen-state storage stability comprising adjusting the pH level of minced fish meat to 7.0 or higher with a non-chelating basic additive other than a polymer phosphate when subjecting fish meat as a raw material of minced fish meat to water leaching.

3. The method according to claim 1, wherein the minced fish meat as a raw material is contaminated by kidneys.

4. The method according to claim 1, wherein the non-chelating basic additive other than a polymer phosphate is selected from the group consisting of sodium bicarbonate, sodium carbonate, arginine, and sodium hydroxide.

5. The method according to claim 1, wherein the polymer phosphate is selected from the group consisting of sodium pyrophosphate, sodium tripolyphosphate, and sodium polyphosphate.

6. The method according to claim 1, wherein the sugar and/or the sugar alcohol are selected from the group consisting of sucrose, sorbitol, glucose, and maltose.

7. The method according to claim 1, wherein (i) the sugar and/or the sugar alcohol, (ii) the polymer phosphate, and (iii) the non-chelating basic additive other than a polymer phosphate are added in amounts of (i) 1% to 20% (w/w), (ii) 0.01% to 5% (w/w), and (iii) 0.01% to 5% (w/w), respectively, relative to the total weight of the minced fish meat.

8. The method according to claim 2, wherein sodium bicarbonate is added in an amount of 0.1% (w/w) or more to water used for water leaching of fish meat.

9. The method according to claim 1, wherein the fish meat as a raw material is selected from the group consisting of Alaska pollack, southern blue whiting, Pacific whiting, lizardfish, New Zealand hoki, mackerel, and saury.

10. Frozen minced fish meat produced by the method according to claim 1.

11. A fish meat paste product produced using the frozen minced fish meat according to claim 10 as a raw material.

12. A degradation inhibitor of trimethylamine-N-oxide (TMAO) of frozen minced fish meat comprising (i) a sugar and/or a sugar alcohol, (ii) a polymer phosphate, and (iii) a non-chelating basic additive other than a polymer phosphate.

13. The degradation inhibitor of trimethylamine-N-oxide (TMAO) according to claim 12, wherein the TMAO is derived from a visceral organ of a fish.

14. The degradation inhibitor of trimethylamine-N-oxide (TMAO) according to claim 12, wherein the non-chelating basic additive other than a polymer phosphate is selected from the group consisting of sodium bicarbonate, sodium carbonate, arginine, and sodium hydroxide.

15. The degradation inhibitor of trimethylamine-N-oxide (TMAO) according to claim 12, wherein the polymer phosphate is selected from the group consisting of sodium pyrophosphate, sodium tripolyphosphate, and sodium polyphosphate.

16. The degradation inhibitor of trimethylamine-N-oxide (TMAO) according to claim 12, wherein the sugar and/or the sugar alcohol are selected from the group consisting of sucrose, sorbitol, glucose, and maltose.

17. The degradation inhibitor of trimethylamine-N-oxide (TMAO) according to claim 12, which comprises (i) the sugar and/or the sugar alcohol, (ii) the polymer phosphate, and (iii) the non-chelating basic additive other than a polymer phosphate in amounts of (i) 1% to 20% (w/w), (ii) 0.01% to 5% (w/w), and (iii) 0.01% to 5% (w/w), respectively, relative to the total weight of the minced fish meat.
